(19) United States
(12) Patent Application Publication
(10) Pub. No.: US 2025/0201165 A1
(43) Pub. Date: Jun. 19, 2025

(54) DISPLAY DEVICE AND METHOD OF DRIVING SAME

(71) Applicant: LG Display Co., Ltd., Seoul (KR)

(72) Inventor: Moo Kyoung HONG, Paju-si (KR)

(73) Assignee: LG Display Co., Ltd., Seoul (KR)

(21) Appl. No.: 18/920,406

(22) Filed: Oct. 18, 2024

(30) Foreign Application Priority Data
Dec. 13, 2023 (KR) 10-2023-0180899

(51) Int. Cl. G09G 3/20; G09G 3/00; G09G 3/3258

(52) U.S. Cl. CPC G09G 3/2074; G09G 3/006; G09G 3/3258; G09G 2300/0819; G09G 2300/0852; G09G 2310/061; G09G 2310/065; G09G 2320/0204; G09G 2330/027; G09G 2330/10

(57) ABSTRACT

A display device can include a display panel including subpixels connected to data lines and reference lines, a driving circuit connected to the data lines, a sensing circuit including a first voltage circuit connected to the reference lines and configured to apply a first reference voltage to initialize sensing nodes of the subpixels, and a sampling circuit configured to perform a sampling operation to sense the sensing nodes of the subpixels. Also, the display device can further include a timing controller configured to generate a first reference voltage control signal for varying a level of the first reference voltage based on a driving frequency of the display panel.

### CROSS-REFERENCE TO RELATED APPLICATION

This application claims priority to Korean Patent Application No. 10-2023-0180899, filed in the Republic of Korea, on Dec. 13, 2023, the entirety of which is hereby incorporated by reference into the present application as if fully set forth herein.

### BACKGROUND

### Field

The present disclosure relates to a display device and a method of driving the same.

### Discussion of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

However, as the resolution and driving frequency of display devices increase, there may not be enough time to perform sensing and compensation for subpixels. Thus, a need exists for a display device that can shorten the amount of time it takes to perform sensing and compensation of the subpixels even at high driving frequencies or high resolutions.

### SUMMARY OF THE DISCLOSURE

Accordingly, the present disclosure is directed to a display device and a method of driving the same that substantially obviate one or more problems due to limitations and disadvantages of the related art.

An object of the present disclosure is to solve the lack of a sensing time by reducing the sensing time such that deterioration of elements included in a display panel of a high-resolution or high-frequency model can be sensed and compensated for, and to improve compensation performance by securing enough time for compensation.

Additional advantages, objects, and features of the present disclosure will be set forth in part in the description which follows and in part will become apparent to those having ordinary skill in the art upon examination of the following or can be learned from practice of the present disclosure. The objectives and other advantages of the present disclosure can be realized and attained by the structure particularly pointed out in the written description and claims hereof as well as the appended drawings.

To achieve these objects and other advantages and in accordance with the purpose of the present disclosure, as embodied and broadly described herein, a display device includes a display panel including subpixels connected to data lines and reference lines, a driving circuit connected to the data lines, a sensing circuit including a first voltage circuit connected to the reference lines and configured to apply a first reference voltage to initialize sensing nodes of the subpixels, and a sampling circuit configured to perform a sampling operation to sense the sensing nodes of the subpixels, and a timing controller configured to control at least one of the driving circuit or the sensing circuit, in which the timing controller generates a first reference voltage control signal for varying a level of the first reference voltage based on a driving frequency of the display panel.

The first reference voltage can vary to a higher level as the driving frequency of the display panel increases.

The first reference voltage can rise from 0 V to 1.x V (x being an integer of 0 or more) under the control of the timing controller.

The display device can further include a power supply configured to provide the first reference voltage to the first voltage circuit, in which the power supply can raise the level of the first reference voltage in response to the first reference voltage control signal output from the timing controller.

The timing controller and the power supply can perform data transmission and reception to transmit and receive signals through an I2C communication method, and the first reference voltage control signal can be included in a data signal transmitted through the I2C communication method.

The display device can further include a digital-to-analog converter configured to provide the first reference voltage to the first voltage circuit, in which the digital-to-analog converter can raise the level of the first reference voltage in response to the first reference voltage control signal output from the timing controller.

The timing controller and the digital-to-analog converter can perform data transmission and reception to transmit and receive signals through an EPI communication method, and the first reference voltage control signal can be included in a data signal transmitted through the EPI communication method.

The driving circuit and the sensing circuit can be included in a data driver, and the first reference voltage can be output from a digital-to-analog converter included in the driving circuit.

In another aspect of the present disclosure, a method of driving the display device includes applying the first reference voltage to the reference lines by driving the first voltage circuit to initialize the sensing nodes of the subpixels, performing a sampling operation on the reference lines by driving the sensing circuit to sense the sensing nodes of the subpixels, and compensating for deterioration of elements included in the display panel based on a sensing voltage acquired through the sampling operation performed on the reference lines, in which a level of the first reference voltage varies in response to a driving frequency of the display panel.

The first reference voltage can vary to a higher level as the driving frequency of the display panel increases.

The first reference voltage can rise from 0 V to 1.x V (x being an integer of 0 or more) under the control of the timing controller.

The applying the first reference voltage and the performing a sampling operation can be performed during a blank period of a vertical synchronization signal to drive the display panel.

It is to be understood that both the foregoing general description and the following detailed description of the present disclosure are examples and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device according to an embodiment of the present disclosure, FIG. 2 is a configuration diagram schematically showing a subpixel shown in FIG. 1 according to an embodiment of the present disclosure, and FIG. 3 is a diagram illustrating a pixel composed of subpixels according to an embodiment of the present disclosure;

FIG. 4 and FIG. 5 are diagrams illustrating the configuration of a gate-in-panel type gate driver according to embodiments of the present disclosure, and FIG. 6 is a diagram showing an example of the arrangement of the gate-in-panel type gate driver according to an embodiment of the present disclosure;

FIG. 7 is a diagram schematically showing a subpixel and a data driver according to an embodiment of the present disclosure, FIG. 8 is a diagram schematically showing a subpixel and a data driver according to an embodiment of the present disclosure, and FIG. 9 is a waveform diagram illustrating a sensing period and a display period according to an embodiment of the present disclosure;

FIG. 10 is a diagram showing some of components included in the data driver according to an embodiment of the present disclosure in more detail, and FIG. 11 and FIG. 12 are diagrams showing a method of sensing a display panel according to embodiments of the present disclosure;

FIG. 13 is a driving waveform diagram for describing a sensing operation of a light emitting display device according to an embodiment of the present disclosure, and FIG. 14 and FIG. 15 are diagrams showing some operating states of the device according to the driving waveforms of FIG. 13 according to embodiments of the present disclosure;

FIG. 16 is a diagram illustrating the relationship between a sensing time and a driving frequency (or resolution) according to an embodiment of the present disclosure, FIG. 17 is a diagram illustrating change in a sensing time according to a first reference voltage raising method according to an embodiment of the present disclosure, and FIG. 18 is a diagram illustrating the advantages of the first reference voltage raising method according to an embodiment of the present disclosure;

FIG. 19 and FIG. 20 are diagrams for briefly describing some components of a light emitting display device and examples of varying a first reference voltage according to embodiments of the present disclosure, and FIG. 21 and FIG. 22 are diagrams for briefly describing an example of transmitting a first reference voltage control signal for varying the first reference voltage based on a first communication method according to embodiments of the present disclosure;

FIG. 23 and FIG. 24 are diagrams illustrating the configuration of each block of a data driver according to embodiments of the present disclosure;

FIG. 25 and FIG. 26 are diagram for briefly describing some components of a light emitting display device and examples of varying the first reference voltage according to an embodiment of the present disclosure, and FIG. 27 is a diagram showing an example of transmitting the first reference voltage control signal for varying the first reference voltage based on a second communication method according to an embodiment of the present disclosure; and

FIG. 28 and FIG. 29 are diagrams illustrating the configuration of each block of the data driver according to embodiments of the present disclosure.

### DETAILED DESCRIPTION OF THE EMBODIMENTS

A display device according to the present disclosure can be implemented as a television system, an image player, a personal computer (PC), a home theater, an automobile electric device, a smartphone, or the like, but is not limited thereto. The display device according to the present disclosure can be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

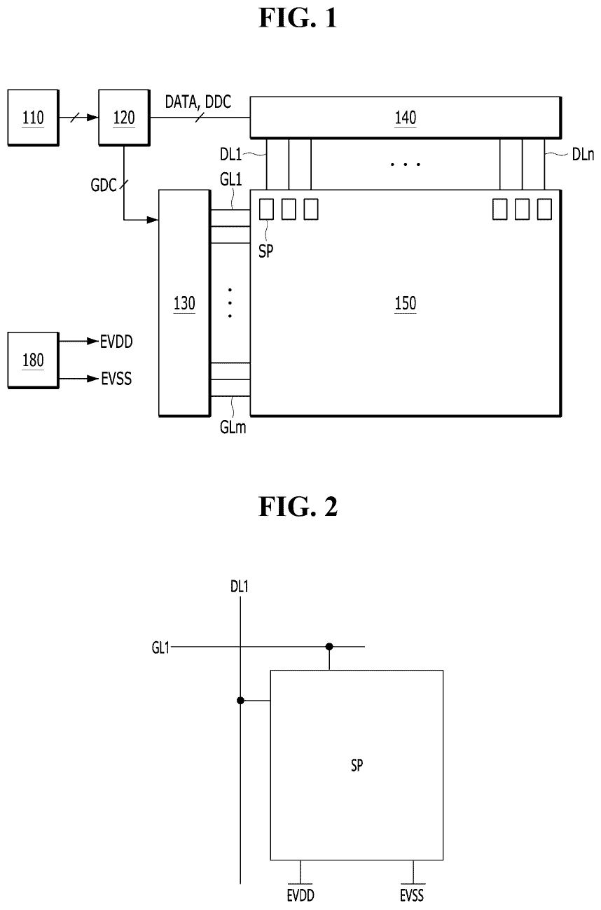

FIG. 1 is a block diagram schematically showing a light emitting display device, FIG. 2 is a configuration diagram schematically showing a subpixel shown in FIG. 1, and FIG. 3 is a diagram showing a pixel composed of subpixels.

As illustrated in FIG. 1, FIG. 2, and FIG. 3, the light emitting display device can include an image provider 110, a timing controller 120, a gate driver 130, a data driver 140, a display panel 150, a power supply 180, and the like.

The image provider 110 (e.g., a set or a host system) can output various driving signals along with an externally supplied image data signal or an image data signal stored in an internal memory. The image provider 110 can supply data signals and various driving signals to the timing controller 120.

The timing controller 120 can output a gate timing control signal GDC for controlling the operation timing of the gate driver 130, a data timing control signal DDC for controlling the operation timing of the data driver 140, and various synchronization signals. The timing controller 120 can supply a data signal DATA supplied from the image provider 110 to the data driver 140 along with the data timing control signal DDC. The timing controller 120 can be implemented in the form of an integrated circuit (IC) and mounted on a printed circuit board, but is not limited thereto.

The gate driver 130 can output a gate signal (or a gate voltage) in response to the gate timing control signal GDC supplied from the timing controller 120. The gate driver 130 can supply gate signals to subpixels included in the display panel 150 through gate lines GL1 to GLm, where m is a real number. The gate driver 130 can be implemented in the form of an IC or directly formed on the display panel 150 in a gate-in-panel structure, but is not limited thereto.

The data driver 140 can sample and latch the data signal DATA in response to the data timing control signal DDC supplied from the timing controller 120, convert the digital data signal into an analog data voltage based on a gamma reference voltage, and output the analog data voltage. The data driver 140 can supply data voltages to the subpixels included in the display panel 150 through data lines DL1 to DLn, where n is a real number. The data driver 140 can be implemented in the form of an integrated circuit (IC) and mounted on the display panel 150 or mounted on a printed circuit board, but is not limited thereto. Also, one or more of the data driver 140, the gate driver 130 and the timing controller 120 can be collectively referred to as a controller.

The power supply 180 can generate first power at a high level and second power at a low level based on an external input voltage supplied from the outside. The power supply 180 can output the first power through a first power line EVDD and output the second power through a second power line EVSS. The power supply 180 can generate and output voltages (e.g., a scan high voltage and a scan low voltage) to drive the gate driver 130 and voltages (e.g., a drain voltage and a half drain voltage) to drive the data driver 140 as well as the first power and the second power.

The display panel 150 can display an image in response to driving signals including a scan signal and a data voltage, the first power, and the second power. The subpixels of the display panel 150 can directly emit light (e.g., no backlight unit needed). The display panel 150 can be manufactured based on a substrate having rigidity or flexibility, such as glass, silicon, polyimide, or the like. For example, one subpixel SP can be connected to the first data line DL1, the first gate line GL1, the first power line EVDD, and the second power line EVSS and can include a pixel circuit including a switching transistor, a driving transistor, a capacitor, an organic light emitting diode, etc.

Subpixels SP used in the light-emitting display device directly emit light, and thus the circuit configuration thereof may be complicated. In addition, there are various compensation circuits that compensate for deterioration of not only the organic light emitting diode emitting light but also the driving transistor that supplies a driving current to drive the organic light emitting diode. Therefore, the subpixel SP is simply shown in the form of a block.

Subpixels emitting light can be composed of red, green, and blue pixels or red, green, blue, and white pixels. For example, one pixel P can include a red subpixel SPR connected to the first data line DL1, a white subpixel SPW connected to the second data line DL2, a green subpixel SPG connected to the third data line DL3, and a blue subpixel SPB connected to the fourth data line DLA. Additionally, the red subpixel SPR, white subpixel SPW, green subpixel SPG, and blue subpixel SPB can be commonly connected to a first reference line VREF1. The first reference line VREF1 can be used to sense deterioration of elements included in one of the red subpixel SPR, white subpixel SPW, green subpixel SPG, and blue subpixel SPB, which will be described below.

Meanwhile, the timing controller 120, the gate driver 130, and the data driver 140 have been described as individual components. However, depending on the implementation method of the light emitting display device, one or more of the timing controller 120, the gate driver 130, and the data driver 140 can be integrated into a single integrated circuit (IC). In addition, the timing controller 120, the gate driver 130, the data driver 140, the power supply 180, and the display panel 150 are an assembly for displaying images and can be defined as a display module.

In addition, as an example, the pixels P in which the red subpixel SPR, white subpixel SPW, green subpixel SPG, and blue subpixel SPB are arranged in order has been illustrated. However, the arrangement order and direction of subpixels can vary depending on the implementation method of the light emitting display device.

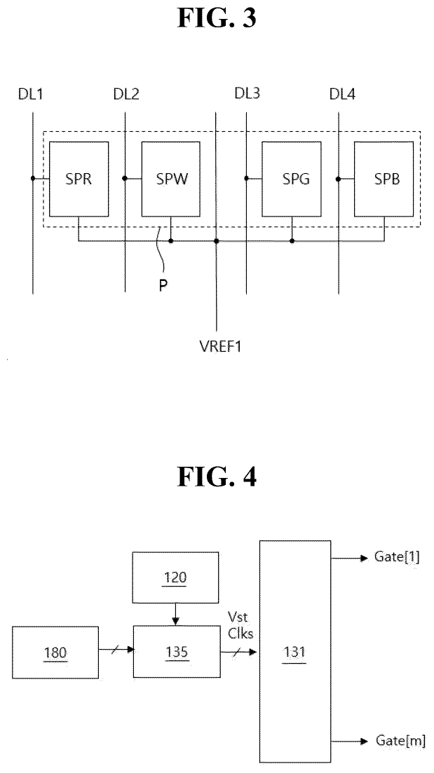

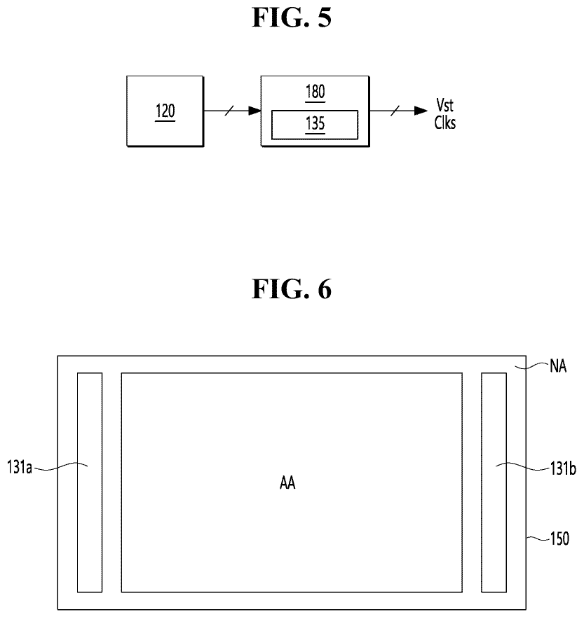

FIG. 4 and FIG. 5 are diagrams illustrating the configuration of a gate-in-panel type gate driver, and FIG. 6 is a diagram showing an example of the arrangement of the gate-in-panel type gate driver.

As shown in FIG. 4, the gate-in-panel type gate driver can include a shift register 131 and a level shifter 135. The level shifter 135 can generate driving clock signals Clks and a start signal Vst based on signals and voltages output from the timing controller 120 and the power supply 180.

The shift register 131 operates based on signals Clks and Vst output from the level shifter 135, and can output gate signals Gate[1] to Gate[m] for turning on or off transistors formed in the display panel. The shift register 131 can take the form of a thin film on the display panel in a gate-in-panel structure.

As shown in FIG. 4 and FIG. 5, unlike the shift register 131, the level shifter 135 can be formed independently in the form of an IC or can be included in the power supply 180. However, this is merely an example and is not limited to thereto.

As shown in FIG. 6, shift registers 131a and 131b that output gate signals in the gate-in-panel type gate driver can be disposed in a non-display area NA of the display panel 150. As an example, the shift registers 131a and 131b are disposed in the left and right non-display areas NA of the display panel 150, but the shift registers 131a and 131b can also be disposed in upper and lower non-display areas NA of the display panel 150 or can be disposed within a display area AA of the display panel 150.

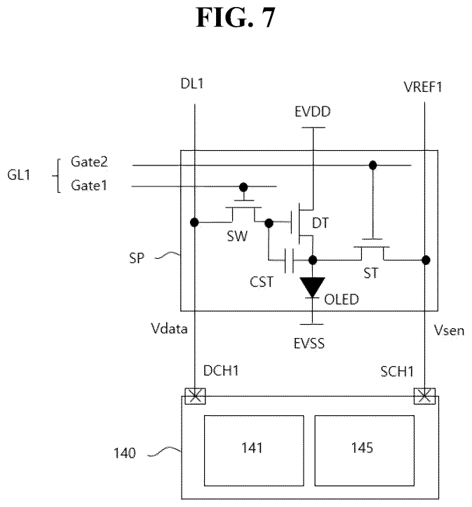

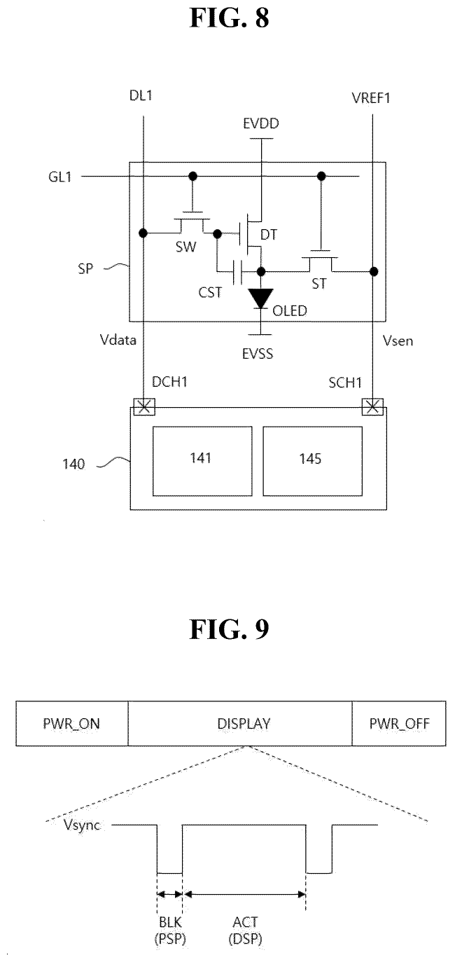

FIG. 7 is a diagram schematically showing a subpixel SP and a data driver 140 according to a first example of an embodiment, FIG. 8 is a diagram schematically showing a subpixel SP and a data driver 140 according to a second example of the embodiment, and FIG. 9 is a waveform diagram illustrating a sensing period and a display period according to an embodiment of the present disclosure.

As shown in FIG. 7, according to the first example, one subpixel SP can include a switching transistor SW, a driving transistor DT, a sensing transistor ST, a capacitor CST, and an organic light emitting diode OLED.

The driving transistor DT can include a gate electrode connected to a first electrode of the capacitor CST, a first electrode connected to the first power line EVDD, and a second electrode connected to the anode of the organic light emitting diode OLED. The capacitor CST can have the first electrode connected to the gate electrode of the driving transistor DT and a second electrode connected to the anode electrode of the organic light emitting diode OLED. The organic light emitting diode OLED can have the anode connected to the second electrode of the driving transistor DT and a cathode connected to the second power line EVSS.

The switching transistor SW can include a gate electrode connected to a first scan line Gate1 included in the first gate line GL1, a first electrode connected to the first data line DL1, and a second electrode connected to the gate electrode of the driving transistor DT. The sensing transistor ST can include a gate electrode connected to a second scan line Gate2 included in the first gate line GL1, a first electrode connected to the first reference line VREF1, and a second electrode connected to the anode of the organic light emitting diode OLED.

The sensing transistor ST is a type of compensation circuit added to compensate for deterioration (e.g., in the threshold voltage, mobility, etc.) of the driving transistor DT or the organic light emitting diode OLED. The sensing transistor ST can enable physical threshold voltage sensing based on the source follower operation of the driving transistor DT. The sensing transistor ST can operate to acquire a sensing voltage through a sensing node defined between the driving transistor DT and the organic light emitting diode OLED.

According to an embodiment, the data driver 140 can include a driving circuit 141 for driving the subpixel SP and a sensing circuit 145 for sensing the subpixel SP. The driving circuit 141 can be connected to the first data line DL1 through a first data channel DCH1. The driving circuit 141 can output a data voltage Vdata for driving the subpixel SP through the first data channel DCH1.

The sensing circuit 145 can be connected to the first reference line VREF1 through a first sensing channel SCH1. The sensing circuit 145 can acquire a sensing voltage Vsen sensed from the subpixel SP through the first sensing channel SCH1. The sensing circuit 145 can acquire the sensing voltage Vsen based on a current sensing or voltage sensing method.

As shown in FIG. 8, according to the second example, the first gate line GL1 can be integrated into one. That is, unlike the first example, the first gate line GL1 may not be divided into the first scan line and the second scan line. In this situation, the switching transistor SW and the sensing transistor ST are both connected to the first gate line GL1 in common, and thus can be turned on or off at the same time.

As shown in FIG. 9, the light emitting display device according to the embodiment can adopt driving modes respectively corresponding to a first operation period PWR_ON (e.g., when powering on the display device), a second operation period DISPLAY, and a third operation period PWR_OFF when operating to drive the display panel (e.g., when powering off the display device).

In more detail, the first operation period PWR_ON can correspond to a driving start period in which power is applied to the display panel, the second operation period DISPLAY can correspond to a panel driving period in which operation such as displaying an image is performed after the power is applied to the display panel, and a third operation period PWR_OFF can correspond to a driving end period in which the power applied to the display panel is cut off. Meanwhile, the third operation period PWR_OFF is a period in which the display panel is driven for a certain period of time while displaying black such that the sensing operation of the display panel can be performed. That is, note that the power applied to the display panel and the like is not completely cut off during the third operation period PWR_OFF. In this way, it can appear to the user that the light emitting display apparatus immediately shuts down in response to an off instruction, but the light emitting display apparatus displays black (displays nothing) but remains on while carrying out the sensing operation before finally shutting down.

The light emitting display device according to the embodiment can sense the display panel in at least one of the first operation period PWR_ON, the second operation period DISPLAY (e.g., during the BLK period), and the third operation period PWR_OFF. As an example, in the second operation period DISPLAY, a blank period BLK included in the vertical synchronization signal Vsync can be defined as a sensing period PSP, and an active period ACT included in the vertical synchronization signal Vsync can be defined as a display period DSP. The light emitting display device according to the embodiment can sense deterioration of the elements included in the subpixels of the display panel in real time during the second operation period DISPLAY.

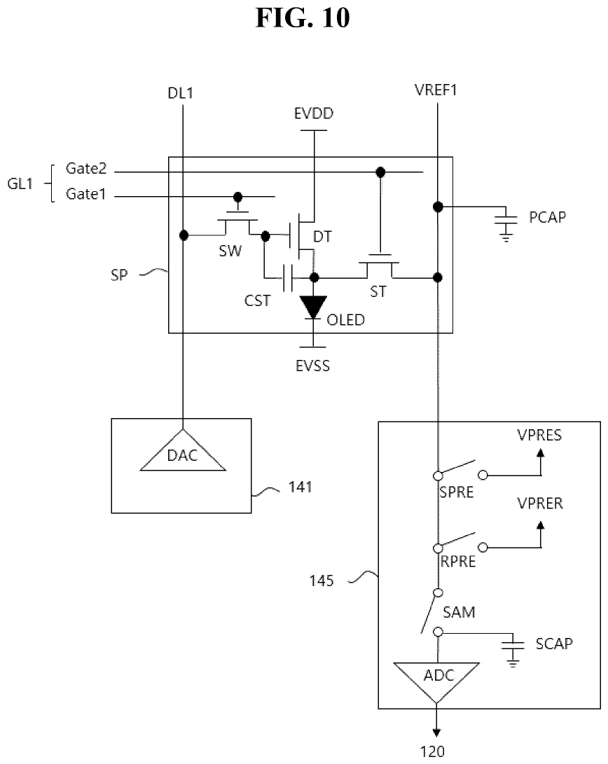

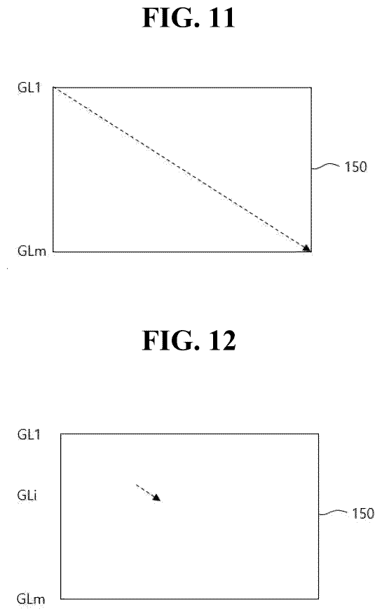

FIG. 10 is a diagram showing some of the components included in the data driver according to an embodiment in more detail, and FIG. 11 and FIG. 12 are diagrams showing a method of sensing the display panel according to embodiments. Hereinafter, as an example, the structure of the subpixel SP shown in FIG. 7 will be described.

As in the embodiment shown in FIG. 10, the driving circuit 141 can include a digital-to-analog converter DAC to output a sensing data voltage, a black data voltage, or a display data voltage through the first data line DL1. The sensing circuit 145 can include a first voltage circuit SPRE, a second voltage circuit RPRE, a sampling circuit SAM, and an analog-to-digital converter ADC to output and sense a voltage through the first reference line VREF1.

The first voltage circuit SPRE and the second voltage circuit RPRE can perform a voltage output operation to initialize nodes or circuits included in the subpixel SP or charge the same to a specific voltage level. The first voltage circuit SPRE and the second voltage circuit RPRE can include a first reference voltage source VPRES and a second reference voltage source VPRER, respectively. The first voltage circuit SPRE can output a first reference voltage based on the first reference voltage source VPRES, and the second voltage circuit RPRE can output a second reference voltage based on the second reference voltage source VPRER. The first reference voltage can be set to a voltage lower than the second reference voltage.

The sampling circuit SAM can perform a sampling operation to acquire a sensing voltage through the first reference line VREF1. For example, the sampling circuit SAM can acquire the sensing voltage from a sensing capacitor PCAP formed on the first reference line VREF1 based on the sensing capacitor PCAP.

The analog-to-digital converter ADC can convert the analog sensing voltage acquired by the sampling circuit SAM into a digital sensing voltage and output the same. For example, the analog-to-digital converter ADC can convert the analog sensing voltage charged in the sensing capacitor PCAP into a digital sensing voltage and output the same.

The timing controller 120 can receive a sensing voltage (sensing data value) from the sensing circuit 145. The timing controller 120 can determine whether the driving transistor DT or organic light emitting diode OLED included in the subpixel SP has deteriorated based on the sensing voltage and perform an operation to compensate for the deterioration. Additionally, the timing controller 120 can determine the presence or absence of a defect in the light emitting display device based on the sensing voltage and perform an operation to notify of or remove the defect.

As shown in FIG. 11, according to the first example, the light emitting display device can perform a sequential sensing method in which sensing is performed from the first gate line GL1 to the M-th gate line GLm of the display panel 150. Although FIG. 11 illustrates an example in which sensing is performed sequentially starting from the first gate line GL1, which is the top of the display panel 150, sensing can start from the M-th gate line GLm, which is the bottom of the display panel 150.

As shown in FIG. 12, according to the second example, the light emitting display device can perform a random sensing method in which only an I-th gate line GLi of the display panel 150 is sensed. Although FIG. 12 illustrates an example in which only the I-th gate line GLi, which is one of specific gate lines, is sensed, the sensing target can be two or more gate lines.

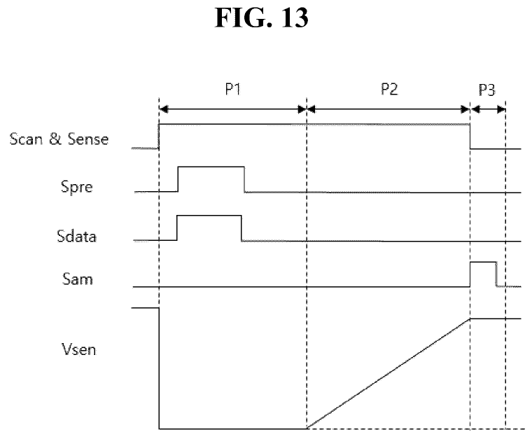

FIG. 13 is a driving waveform diagram for describing a sensing operation of a light emitting display device according to an embodiment, and FIG. 14 and FIG. 15 are diagrams showing some operating states of the device according to the driving waveforms of FIG. 13.

As shown in FIG. 13, the light emitting display device according to the embodiment can perform operations throughout a first period P1, a second period P2, and a third period P3 to sense deterioration of elements included in the subpixels SP.

As shown in FIG. 13 and FIG. 14, a scan signal Scan and a sensing signal Sense can be applied as a turn-on voltage (e.g., high voltage) during the first period P1 and the second period P2 and applied as a turn-off voltage (e.g., low voltage) during the third period P3. The switching transistor SW (e.g., scan) and the sensing transistor ST (e.g., sense) included in the subpixel SP can be turned on by the scan signal Scan and the sensing signal Sense of the turn-on voltage applied during the first period P1 and the second period P2.

A first voltage circuit control signal Spre can be applied as a turn-on voltage (e.g., high voltage) during the first period P1 and applied as a turn-off voltage (e.g., low voltage) during the second period P2 and the third period P3. The first voltage circuit SPRE can be turned on (e.g., to close a switch) to output a first reference voltage Vpres by the first voltage circuit control signal Spre of the turn-on voltage applied during the first period P1. The first reference voltage Vpres applied during the first period P1 can be applied to the sensing node to which the source electrode (e.g., that is the second electrode) of the driving transistor DT and the second electrode of the capacitor CST are connected through the first reference line VREF1 of the subpixel SP and the turned-on sensing transistor ST. The sensing node can be initialized by the first reference voltage Vpres applied during the first period P1.

A sensing data voltage Sdata can be applied during the first period P1 and may not be applied during the second period P2 and the third period P3 via a first data line DL1. The sensing data voltage Sdata applied during the first period P1 can be applied to the gate node to which the gate electrode of the driving transistor DT and the first electrode of the capacitor CST are connected through the turned-on switching transistor SW.

As shown in FIG. 13, the switching transistor SW and the sensing transistor ST can be turned on during the second period P2. The driving transistor DT can operate as a constant current source by the sensing data voltage Sdata charged in the capacitor CST.

As the driving transistor DT operates as a constant current source, a sensing voltage Vsen that can be obtained from the sensing node can increase. Here, the change in the sensing voltage Vsen that can be obtained from the sensing node can be proportional to the current of the driving transistor DT. Accordingly, the sensing voltage Vsen that can be obtained from the sensing node can rise to a level close to the threshold voltage of the driving transistor DT and then saturate. The sensing voltage Vsen can also be charged in the sensing capacitor PCAP formed on the first reference line VREF1 of the subpixel SP and the threshold voltage of the driving transistor DT can then be sensed.

As shown in FIG. 13 and FIG. 15, a sampling control signal Sam can be applied as a turn-on voltage during the third period P3. The sampling circuit SAM can be turned on by the sampling control signal Sam of the turn-on voltage applied during the third period P3. On the other hand, the switching transistor SW and the sensing transistor ST included in the subpixel SP can be turned off during the third period P3.

The sensing voltage Vsen charged in the sensing capacitor PCAP of the first reference line VREF1 (or the sensing voltage charged in the sensing node) can be charged in the sampling capacitor SCAP of the sampling circuit SAM according to the sampling operation of the sampling circuit SAM.

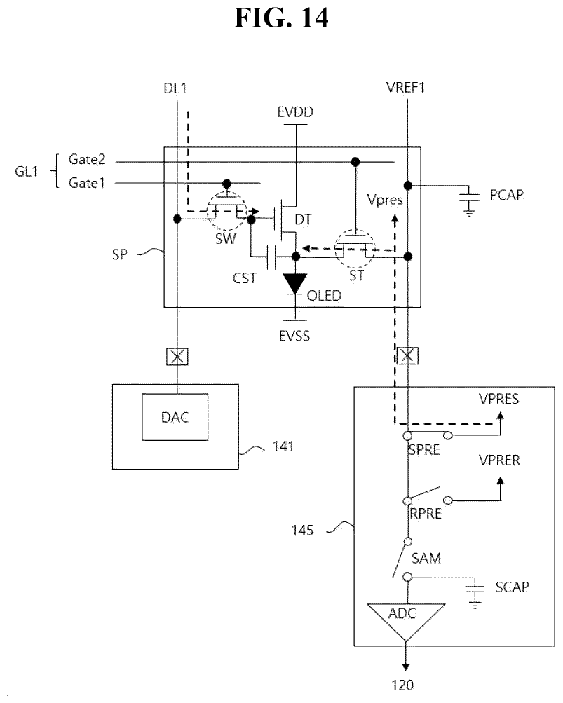

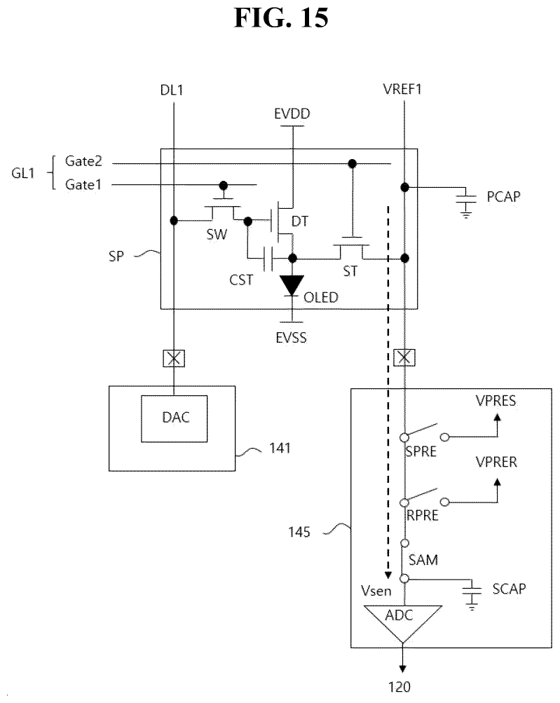

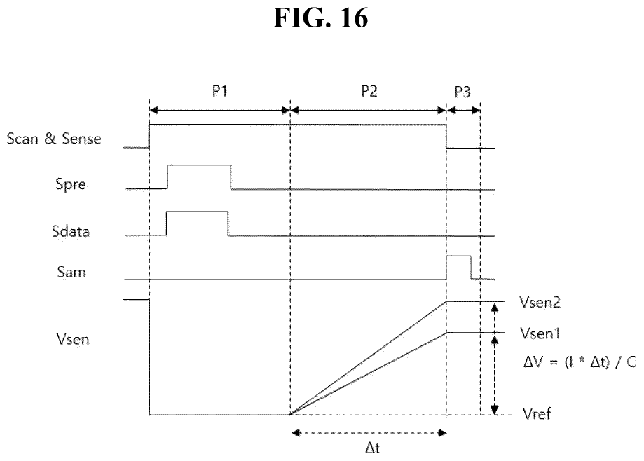

FIG. 16 is a diagram illustrating the relationship between a sensing time and a driving frequency (or resolution), FIG. 17 is a diagram illustrating changes in the sensing time according to a first reference voltage raising method according to an embodiment, and FIG. 18 is a diagram illustrating the advantages of the first reference voltage raising method according to the embodiment.

As shown in FIG. 16, the sensing voltage Vsen acquired through the sampling operation during the third period P3 can be defined as a voltage that rises from the reference voltage Vref and reaches a level close to the threshold voltage of the driving transistor.

The sensing voltage Vsen can be acquired as a first sensing voltage Vsen1 having a first slope or as a second sensing voltage Vsen2 having a second slope. As can be ascertained by referring to the voltage difference expression ΔV=(I*Δt)/C, in which I is the current of the driving transistor DT, Δt is the sensing time, and C is the capacitance of the capacitor CST, the factor that has the greatest influence on the sensing voltage Vsen is the sensing time Δt. That is, even if the same subpixel is sensed, the level of the sensing voltage Vsen can vary if there is a condition that can cause a difference in the sensing time Δt, such as a driving frequency or resolution.

As shown in FIG. 17, the sensing method according to the embodiment raises the level of the first reference voltage, which is a criterion for the sensing voltage Vsen, compared to the previous level. In other words, the level of the first reference voltage used for initialization rises compared to the previous level. For example, when the resolution or driving frequency is increased, then the level of the first reference voltage can be increased.

A first sample Vsena and a first sample group Vsenag in FIG. 17 are examples showing changes in the slope of the sensing voltage when the level of the first reference voltage is set to 0 V, and a second sample Vsenb and a second sample group Vsenbg in FIG. 17 are examples showing changes in the slope of the sensing voltage when the level of the first reference voltage is set to 1.x V (x being an integer of 0 or more).

As can be ascertained from the examples of FIG. 17, if the level of the first reference voltage used for initialization rises, the same slope as that at a second sensing time Samt2 can be obtained even at a first sensing time Samt1 which is earlier than the second sensing time Samt2. In other words, according to the embodiment, the sensing time can be advanced to a first time \textcircled{b} which is earlier than a second time \textcircled{a} by raising the level of the first reference voltage used for initialization to at least 1.0 V. For example, this can help in a situation where the driving frequency is higher and there is less time available to performing sensing.

As shown in FIG. 18, the degradation sensing method according to the embodiment can be performed during a blank period BLK included in the vertical synchronization signal Vsync. The blank period BLK can be shortened or lengthened depending on conditions that determine the driving frequency, such as the vertical synchronization signal Vsync.

For example, the blank period BLK of the vertical synchronization signal Vsync generated based on a driving frequency of 60 Hz is longer than the blank period BLK of the vertical synchronization signal Vsync generated based on a driving frequency of 240 Hz. For this reason, when the driving frequency of the light emitting display device is 240 Hz, the time required to acquire the sensing voltage is shorter than that when the driving frequency is 60 Hz. This problem can also occur when the driving frequency increases and the display panel is implemented as a high-resolution and high pixel-per-inch (PPI) model.

Therefore, as in the embodiment, the sensing voltage acquisition method for raising the level of the first reference voltage used for initialization can be advantageous when the driving frequency increases from a first frequency to a second frequency or the method is applied to a model with high resolution (e.g., high frequency, high resolution, and high PPI). In this way, when the driving frequency is set higher or when the resolution is increased, then the level of the first reference voltage used for initialization, in order to perform sensing in a shorter amount of time and ensure that an accurate measurement can be obtained within the blank period BLK of the vertical synchronization signal Vsync.

In addition, the degradation sensing method according to the embodiment can control related elements such that, when at least one of the frequency, resolution, or PPI increases, the first reference voltage also rises in response thereto. Additionally, the degradation sensing method according to the embodiment can use a look-up table to provide a preferable first reference voltage in response to at least one of the frequency, resolution, or PPI.

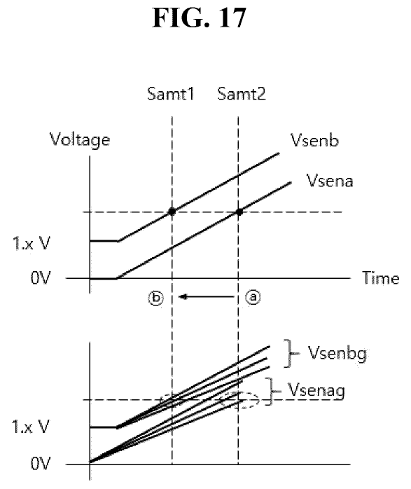

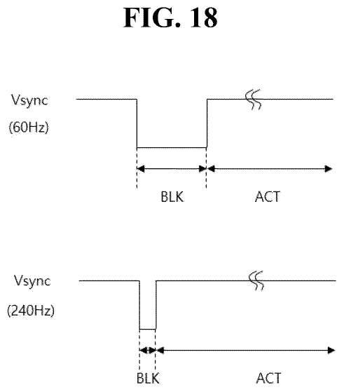

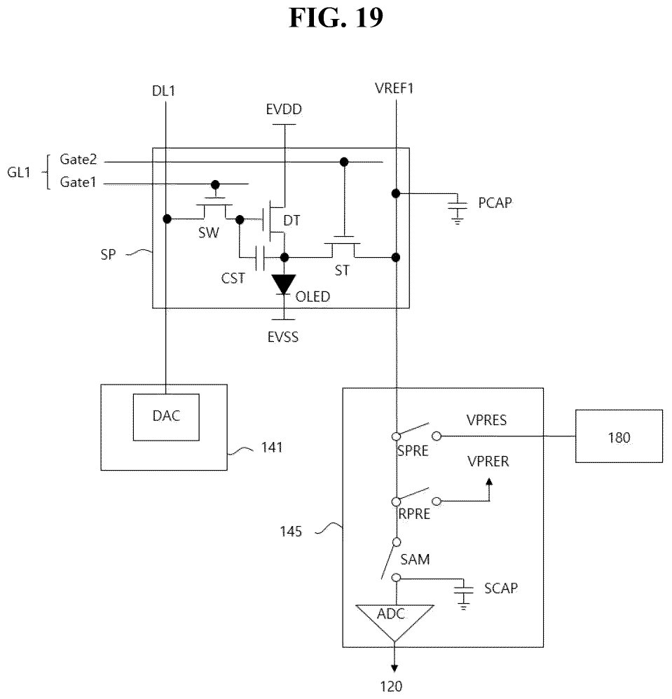

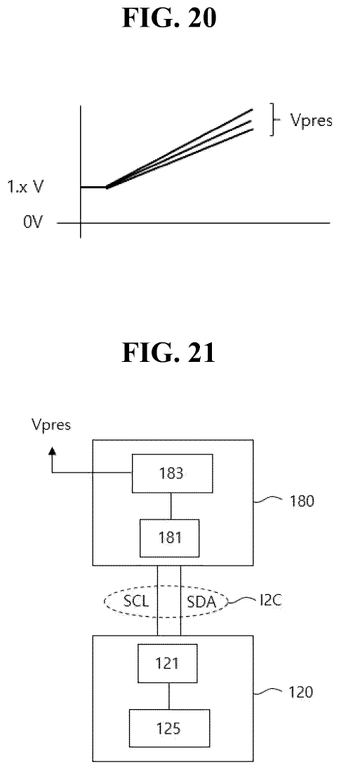

FIG. 19 and FIG. 20 are diagrams for briefly describing some components of a light emitting display device and examples of varying the first reference voltage according to a first embodiment, and FIG. 21 and FIG. 22 are diagrams for briefly describing an example of transmitting the first reference voltage control signal for varying the first reference voltage based on a first communication method according to the first embodiment.

As shown in FIG. 19 and FIG. 20, according to the first embodiment, the first voltage circuit SPRE included in the sensing circuit 145 can be connected to one of the output terminals of the power supply 180. The first voltage circuit SPRE can use the voltage output from one of the output terminals of the power supply 180 as the first reference voltage Vpres used to initialize a sensing node. When at least one of the frequency, resolution, or PPI increases, the first reference voltage Vpres can be also be increased and output as 1.x V (x being an integer of 0 or more), which is higher than 0 V, in response. That is, when at least one of the frequency, resolution, or PPI increases, the power supply 180 can vary or dynamically increase the level of the first reference voltage Vpres to 1.x, which is higher than 0 V, and output the same in response.

As shown in FIG. 21 and FIG. 22, according to the first embodiment, the power supply 180 can vary the level of the first reference voltage Vpres and output the same under the control of the timing controller 120. The power supply 180 and the timing controller 120 can perform data transmission and reception for transmitting and receiving signals through the first communication method.

The timing controller 120 can include a first interface 121 and a controller 125. The power supply 180 can include a second interface 181 and a first reference voltage generator 183.

A clock line SCL and a data line SDA can be provided between the first interface 121 of the timing controller 120 and the second interface 181 of the power supply 180 to transmit and receive signals using I2C communication method corresponding to an example of the first communication method. For example, an I2C communication method can include a two0wire interface using two wires for communication, for a serial data line SDA and a serial clock line SCL (e.g., I2C can use a sequence of ones and zeros for serial communication). A clock signal Scl for enabling start and stop of signal transmission between the first interface 121 and the second interface 181 can be transmitted through the clock line SCL. A data signal Sda for enabling data transmission between the first interface 121 and the second interface 181 can be transmitted through the data line SDA.

The controller 125 of the timing controller 120 can generate a first reference voltage control signal Vpresc for controlling the first reference voltage and control the first interface 121 such that the first reference voltage control signal Vpresc is transmitted to the first reference voltage generator 183 included in the power supply 180. The first reference voltage control signal Vpresc can be transmitted by being included in a data signal I2C DATA transmitted through the I2C communication method, as shown in FIG. 22.

The power supply 180 can extract the first reference voltage control signal Vpresc from the signal received through the second interface 181 and transmit the same to the first reference voltage generator 183. The first reference voltage generator 183 can vary the level of the first reference voltage Vpres in response to a data value included in the first reference voltage control signal Vpresc.

Meanwhile, the controller 125 can generate the first reference voltage control signal Vpresc when the driving frequency is changed from the first frequency (e.g., 60 Hz) to the second frequency (120 Hz, 240 Hz, or more). In addition, the controller 125 can change the data value included in the first reference voltage control signal Vpresc into a form that can vary the level of the first reference voltage Vpres in response to the driving frequency.

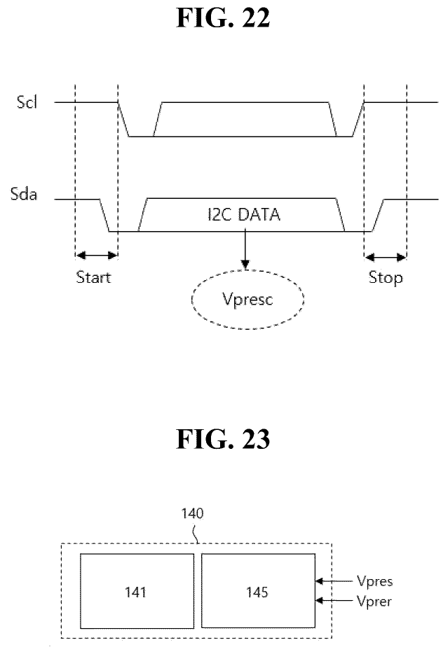

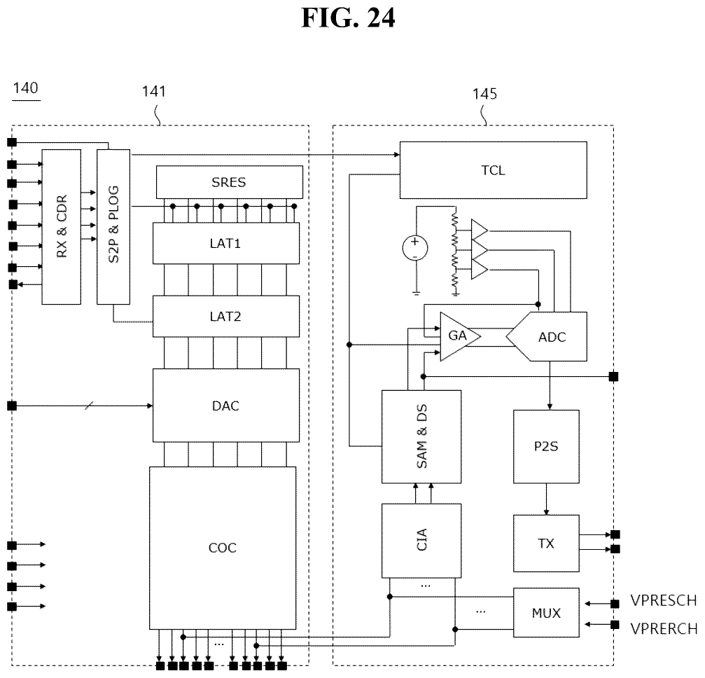

FIG. 23 and FIG. 24 are diagrams illustrating the configuration of each block of a data driver according to the first embodiment.

As shown in FIG. 23 and FIG. 24, according to the first embodiment, the data driver 140 includes a driving circuit 141 for driving subpixels SP and a sensing circuit 145 for sensing the subpixels SP.

The driving circuit 141 can include a data reception and recovery unit RX & CDR, a first data processing and logic unit S2P & PLOG, a shift register SRES, a first latch LAT1, a second latch LAT2, a digital-to-analog converter DAC, and an output circuit COC.

The data reception and recovery unit RX & CDR can serve to receive and process packet data transmitted from the timing controller and to recover errors in reception of a data signal or a clock signal included in the packet data if the errors have occurred.

The first data processing and logic unit S2P & PLOG can serve to convert a serial signal output from the data reception and recovery unit RX & CDR into a parallel signal and to separately output a control signal to be applied to a controller TCL and a data signal to be applied to the first latch LAT1.

The shift register SRES can serve to generate a signal such that the data signal applied to the first latch LAT1 or the second latch LAT2 is sampled and latched for one line.

The first latch LAT1 and the second latch LAT2 can serve to sample, latch, and output the data signal output from the first data processing and logic unit S2P & PLOG for one line. Here, the second latch LAT2 can output a data signal based on a source output enable signal output from the first data processing and logic unit S2P & PLOG.

The digital-to-analog converter DAC can serve to convert a digital data signal output from the second latch LAT2 into an analog data voltage based on a gamma reference voltage and output the analog data voltage.

The output circuit COC can serve to perform additional modulation, such as amplifying the data voltage output from the digital-to-analog converter DAC, and then output the same through a data channel.

The sensing circuit 145 can include the controller TCL, a sensing processor CIA, a multiplexer MUX, a sampling and downscaling unit SAM & DS, a gain amplifier GA, an analog-to-digital converter ADC, a second data processor P2S, and a data transmitter TX.

The controller TCL can serve to control the operation timing of elements included in the sensing circuit 145 based on a control signal output from the first data processing and logic unit S2P & PLOG.

The sensing processor CIA can serve to acquire a sensing voltage through a sensing channel connected to a reference line, process the sensing voltage, and output the processed sensing voltage. The sensing processor CIA can be configured according to the sensing method of the sensing circuit 145. For example, the sensing processor CIA can be configured as a current integration circuit or a voltage sensing circuit.

The multiplexer MUX can serve to selectively output the first reference voltage Vpres and the second reference voltage Vprer applied from the outside. The multiplexer MUX can include a first voltage circuit that outputs the first reference voltage Vpres and a second voltage circuit that outputs the second reference voltage Vprer. The first voltage circuit can receive the first reference voltage Vpres through a first reference voltage input terminal VPRESCH, and the second voltage circuit can receive the second reference voltage through a second reference voltage input terminal VPRERCH.

The sampling and downscaling unit SAM & DS can serve to sample the sensing voltage acquired by the sensing processor CIA and to downscale the sensing voltage. As shown in FIG. 24, the sampling and downscaling unit SAM & DS can sample the sensing voltage in the form of an analog signal output from the sensing processor CIA into a sampled analog signal and downscale the sampled analog signal to output the same as a sampled and downscaled analog signal.

The gain amplifier GA can serve to control the gain of the sensing voltage output from the sampling and downscaling unit SAM & DS. The analog-to-digital converter ADC can serve to convert the analog sensing voltage output from the gain amplifier GA into a digital sensing voltage (e.g., sensing data value) and output the digital sensing voltage.

The second data processor P2S can serve to process parallel digital sensing voltages output from the analog-to-digital converter ADC into a serial digital sensing voltage. The data transmitter TX can serve to transmit the serial digital sensing voltage output from the second data processor P2S to the timing controller.

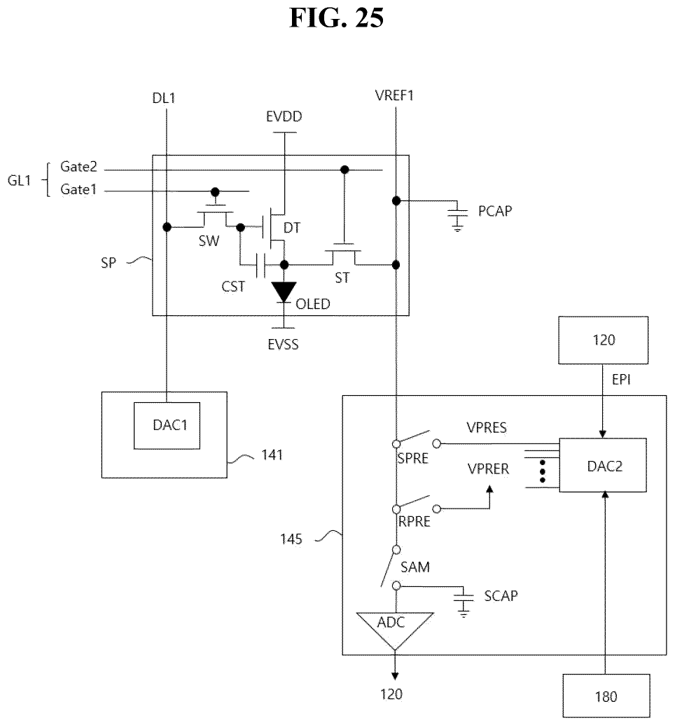

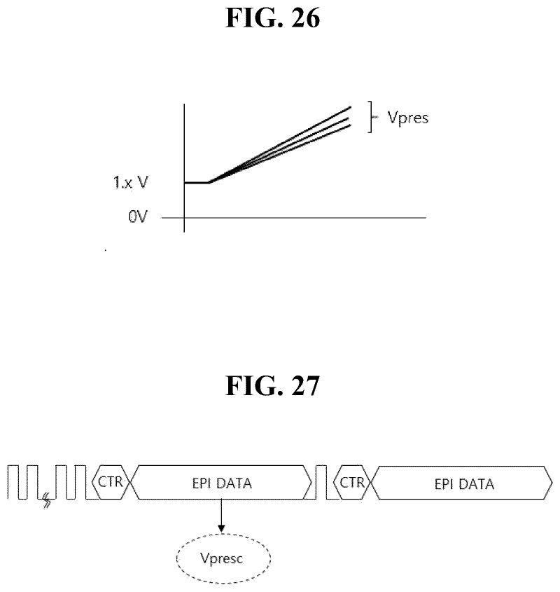

FIG. 25 and FIG. 26 are diagram for briefly describing some components of a light emitting display device and examples of varying the first reference voltage according to a second embodiment, and FIG. 27 is a diagram showing an example of transmitting the first reference voltage control signal for varying the first reference voltage based on a second communication method according to the second embodiment.

As shown in FIG. 25, FIG. 26, and FIG. 27, according to the second embodiment, the first voltage circuit SPRE included in the sensing circuit 145 can be connected to one of the output terminals of a second digital-to-analog converter DAC2. The first voltage circuit SPRE can use the voltage output from one of the output terminals of the second digital-to-analog converter DAC2 as the first reference voltage Vpres used to initialize a sensing node. The first reference voltage Vpres can be changed by the second digital-to-analog converter DAC2 and output as 1.x V (x being an integer of 0 or more) which is higher than 0 V.

The second digital-to-analog converter DAC2 can generate the first reference voltage Vpres based on the voltage output from the power supply 180. The second digital-to-analog converter DAC2 can vary the level of the first reference voltage Vpres and output the same under the control of the timing controller 120.

The sensing circuit 145 and the timing controller 120 can perform data transmission and reception for transmitting and receiving signals through the second communication method. The sensing circuit 145 and the timing controller 120 can transmit and receive signals using an embedded clock point-to-point interface (EPI) which is an example of the second communication method. For example, embedded clock point-to-point interface (EPI) communication can transmit high-speed data, in which the clock signal can be embedded within the data stream itself (e.g., a separate clock line can be eliminated), can use point-to-point connections. Data signals, control signals, and clock signals can be transmitted in the form of differential signals through wire pairs using the EPI communication method. For example, EPI can be faster than I2C and can use point-to-point connections and embedded clocking, while I2C can employ a shared two-wire bus and a separate clock line.

The timing controller 120 can generate a first reference voltage control signal Vpresc for controlling the first reference voltage and transmit the same to the sensing circuit 145. The first reference voltage control signal Vpresc can be transmitted by being included in a data signal EPI DATA transmitted through the EPI communication method. CTR indicates a control signal used when data is transmitted through the EPI communication method, as shown in FIG. 27.

The second digital-to-analog converter DAC2 can vary the level of the first reference voltage Vpres in response to a data value included in the first reference voltage control signal Vpresc. Meanwhile, an example in which the driving circuit 141 includes the first digital-to-analog converter DAC1, the sensing circuit 145 includes the second digital-to-analog converter DAC2, and the driving circuit 141 and the sensing circuit 145 are distinguished from each other has been described above. However, the sensing circuit 145 can use the first digital-to-analog converter DAC1 included in the driving circuit 141 instead of including the second digital-to-analog converter DAC2, which will be described below.

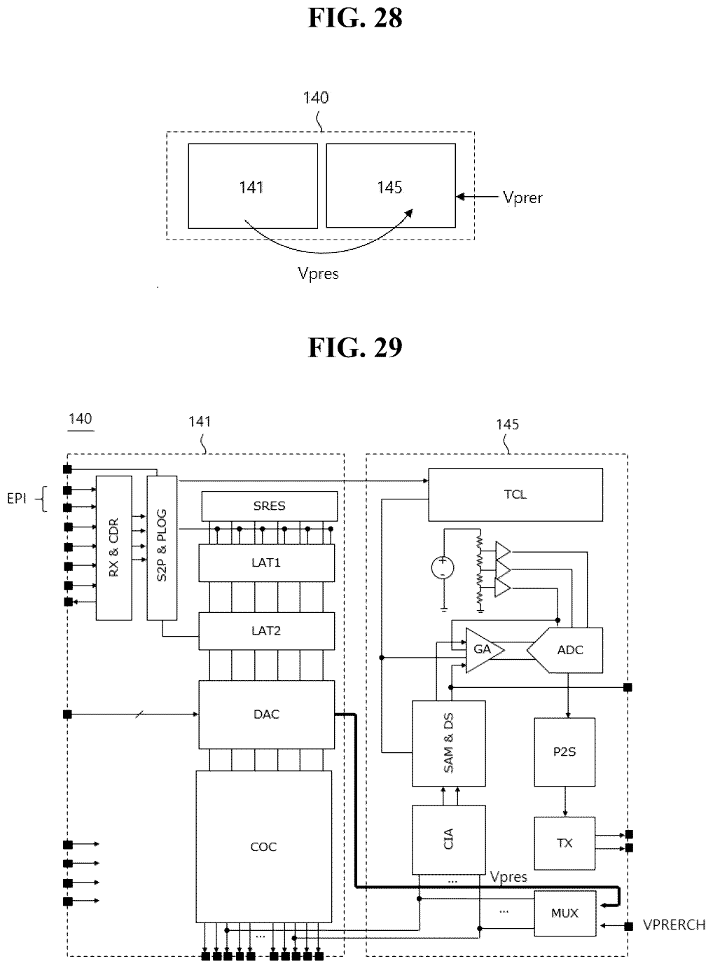

FIG. 28 and FIG. 29 are diagrams illustrating the configuration of each block of the data driver according to the second embodiment.

As shown in FIG. 28 and FIG. 29, according to the second embodiment, the data driver 140 can include the driving circuit 141 for driving the subpixels SP and the sensing circuit 145 for sensing the subpixels SP.

The driving circuit 141 can include a data reception and recovery unit RX & CDR, a first data processing and logic unit S2P & PLOG, a shift register SRES, a first latch LAT1, a second latch LAT2, a digital-to-analog converter DAC, and an output circuit COC.

The sensing circuit 145 can include a controller TCL, a sensing processor CIA, a multiplexer MUX, a sampling and downscaling unit SAM & DS, a gain amplifier GA, an analog-to-digital converter ADC, a second data processor P2S, and a data transmitter TX.

According to the second embodiment, the sensing circuit 145 can use the voltage output from one of the output terminals of the analog-to-digital converter ADC included in the driving circuit 141 as the first reference voltage Vpres. That is, the first reference voltage Vpres can be output from one of the output terminals of the analog-to-digital converter ADC included in the driving circuit 141.

Accordingly, unlike the first embodiment, the data driver 140 according to the second embodiment can separately receive only the second reference voltage Vprer from the outside. In other words, although the multiplexer MUX includes a first voltage circuit that outputs the first reference voltage Vpres and a second voltage circuit that outputs the second reference voltage Vprer, only the second reference voltage Vprer can be separately applied from the outside since the first reference voltage Vpres is generated in the data driver 140. Therefore, the data driver 140 can include only the second reference voltage input terminal VPRERCH through which the second reference voltage is input, and the first reference voltage input terminal through which the first reference voltage is input may not be included (can be omitted or removed).

As described above, the present disclosure has the effect of reducing a sensing time such that deterioration of elements included in a display panel of a high-resolution or high-frequency model can be sensed and compensated for. In addition, the present disclosure has the effect of resolving the lack of sensing time that can occur in a display panel of a high-resolution or high-frequency model and improving compensation performance by securing enough time required for sensing and compensation.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display device comprising:
a display panel including subpixels connected to data lines and reference lines;
a driving circuit connected to the data lines;
a sensing circuit including a first voltage circuit connected to the reference lines and configured to apply a first reference voltage to initialize sensing nodes of the subpixels, and a sampling circuit configured to perform a sampling operation to sense the sensing nodes of the subpixels; and
a timing controller configured to:
generate a first reference voltage control signal for varying a level of the first reference voltage based on a driving frequency of the display panel.

2. The display device of claim 1, wherein the varying the level of the first reference voltage includes changing the first reference voltage from a lower level to a higher level when the driving frequency of the display panel is increased.

3. The display device of claim 1, wherein the first reference voltage rises from 0 V to 1.x V, where x is an integer of 0 or more.

4. The display device of claim 1, further comprising a power supply configured to:
raise the level of the first reference voltage from a lower level to a higher level and supply the first reference voltage having the higher level to the first voltage circuit, in response to the first reference voltage control signal output from the timing controller.

5. The display device of claim 4, wherein the timing controller and the power supply perform data transmission and reception to transmit and receive signals through an Inter-Integrated Circuit (I2C) communication method, and the first reference voltage control signal is included in a data signal transmitted through the I2C communication method.

6. The display device of claim 1, further comprising a digital-to-analog converter configured to provide the first reference voltage to the first voltage circuit,
wherein the digital-to-analog converter varies the level of the first reference voltage in response to the first reference voltage control signal output from the timing controller.

7. The display device of claim 6, wherein the timing controller and the digital-to-analog converter perform data transmission and reception to transmit and receive signals through an Embedded Clock Point-to-Point (EPI) communication method, and the first reference voltage control signal is included in a data signal transmitted through the EPI communication method.

8. The display device of claim 1, wherein the driving circuit and the sensing circuit are included in a data driver, and the first reference voltage is output from a digital-to-analog converter included in the driving circuit.

9. The display device of claim 1, wherein the first voltage circuit is configured to apply the first reference voltage during a blank period of a vertical synchronization signal, and
wherein the sampling circuit is configured to perform the sampling operation during the blank period.

10. A method of controlling a display device, the method comprising:
applying, by a sensing circuit including in the display device, a first reference voltage to reference lines connected to subpixels in a display panel of the display device by driving a first voltage circuit in the sensing circuit to initialize the sensing nodes of the subpixels;
performing, by the sensing circuit, a sampling operation on the reference lines by driving the sensing circuit to sense the sensing nodes of the subpixels;
compensating for deterioration of elements included in the display panel based on a sensing voltage acquired through the sampling operation performed on the reference lines; and
in response to a driving frequency of the display panel changing, changing a level of the first reference voltage by a timing controller in the display device.

11. The method of claim 10, wherein the first reference voltage is transitioned from a lower level to a higher level when the driving frequency of the display panel is increased.

12. The method of claim 10, wherein the first reference voltage rises from 0 V to 1.x V, where x is an integer of 0 or more.

13. The method of claim 10, wherein the applying the first reference voltage and the performing the sampling operation are performed during a blank period of a vertical synchronization signal to drive the display panel.

14. A display device comprising:
a display panel including subpixels connected to data lines and reference lines;
a data driver connected to the data lines and the reference lines, the data driver being configured to supply a first reference voltage to at least one of the reference lines for performing a sampling operation on at least one of the subpixels; and
a controller configured to:
in response to a driving frequency or a resolution of the display panel changing, changing a level of the first reference voltage.

15. The display device of claim 14, wherein the controller is further configured to:
in response to the driving frequency of the display panel transitioning from a first driving frequency to a second driving frequency that is higher than the first driving frequency, transition the first reference voltage from a first level to a second level that is higher than the first level.

16. The display device of claim 15, wherein the sampling operation is performed during a blank period of a vertical synchronization signal,
wherein the blank period during driving of the display panel according to the first driving frequency has a first time period, and
wherein the blank period during driving of the display panel according to the second driving frequency has a second time period shorter than the first time period.

17. The display device of claim 15, wherein the controller is further configured to:
communicate with the data driver through an Inter-Integrated Circuit (I2C) communication protocol while display panel is driven at the first driving frequency, and
communicate with the data driver through an Embedded Clock Point-to-Point (EPI) communication protocol while display panel is driven at the second driving frequency.

18. The display device of claim 15, wherein the first level of the first reference voltage is 0 V, and
wherein the second level of the first reference voltage is 1.x V, where x is an integer greater than 0.

19. The display device of claim 15, further comprising a power supply configured to:
raise the first reference voltage from the first level to the second level and supply the first reference voltage having the second level to the at least one of the subpixels, in response to a first reference voltage control signal output from the controller.

20. The display device of claim 14, wherein the controller is further configured to:
supply a compensation voltage to the at least one of the subpixels based on a sensing voltage acquired through the sampling operation.
